(19) United States
(12) Patent Application Publication
(10) Pub. No.: US 2026/0284900 A1
(43) Pub. Date: Sep. 24, 2026

(54) INFORMATION PROCESSING DEVICE, ROBOT, AND INFORMATION PROCESSING METHOD

(71) Applicant: MITSUBISHI ELECTRIC CORPORATION, Tokyo (JP)

(72) Inventors: Kengo AKAHO, Tokyo (JP); Dongsuk PARK, Tokyo (JP); Hirotake ODAGIRI, Tokyo (JP); Naoki TSURU, Tokyo (JP)

(73) Assignee: MITSUBISHI ELECTRIC CORPORATION, Tokyo (JP)

(21) Appl. No.: 19/479,843

(22) PCT Filed: Jun. 14, 2023
(86) PCT No.: PCT/JP2023/022043

§ 371 Date: Oct. 29, 2025

(51) Int. Cl. B25J 11/00

(52) U.S. Cl. CPC B25J 11/0045; B25J 11/008

(57) ABSTRACT

An information processing unit (2) according to the present disclosure is an information processing device that controls a robot (1) that includes a movable unit (3) and provides a service to a user by operating the movable unit (3), the information processing device including: an acquisition unit (21) that acquires user information including a state of the user and/or an environment around the user; a determination unit (22) that determines a timing for providing a service by using the user information; and an operation control unit (23) that generates a command for providing a service at the timing when the robot (1) is determined based on the timing determined.

### FIELD

The present disclosure relates to an information processing device, a robot, a service providing system, an information processing method, and a program for controlling a robot that provides a service.

### BACKGROUND

Use of robots in various situations such as home and workplace is expected. Patent Literature 1 discloses a self-propelled robot including an articulated arm and a hand connected to a distal end of the arm and gripping an object. In the technique described in Patent Literature 1, an instruction from a user and an operation of a robot corresponding to the instruction are associated in advance, and when an instruction from the user such as “I want to drink juice” is input, the robot performs the operation associated with the instruction.

### Citation List

### Patent Literature

Patent Literature 1: Japanese Patent No. 5380630

### SUMMARY OF INVENTION

### Problem to Be Solved by the Invention

In the technique described in Patent Literature 1, in response to an instruction from a user, an operation corresponding to the instruction is performed by a robot. For this reason, the user needs to explicitly indicate an instruction corresponding to a desired operation to the robot, and there is a problem that it takes time and effort for the user to receive a service provided by the robot.

The present disclosure has been made in view of the above, and an object thereof is to obtain an information processing device that enables provision of a service to a user by a robot while saving the user's time and effort.

### Means to Solve the Problem

In order to solve the above-described problems and achieve the object, an information processing device according to the present disclosure is an information processing device that controls a robot that includes a movable unit and provides a service to a user by operating the movable unit, the information processing device including: an acquisition unit that acquires user information including a state of the user and/or an environment around the user; a determination unit that determines a timing for providing a service by using the user information; and a command generation unit that generates an instruction for providing a service at the timing when the robot is determined based on the timing determined.

### Effects of the Invention

The information processing device according to the present disclosure can achieve the effect of enabling provision of a service to a user by a robot while saving the user's time and effort.

### BRIEF DESCRIPTION OF DRAWINGS

FIG. 1 is a diagram illustrating an exemplary configuration of a service providing system according to the first embodiment.

FIG. 2 is a diagram schematically illustrating service provision by the robot of the first embodiment.

FIG. 3 is a flowchart illustrating exemplary operation of the robot of the first embodiment.

FIG. 4 is a diagram illustrating another exemplary configuration of the service providing system according to the first embodiment.

FIG. 5 is a diagram illustrating another exemplary configuration of the service providing system according to the first embodiment.

FIG. 6 is a diagram illustrating an exemplary configuration of a computer system that implements the information processing device according to the first embodiment.

FIG. 7 is a conceptual diagram illustrating an example of a service provided by the service providing system according to the second embodiment.

FIG. 8 is a flowchart illustrating exemplary operation of the robot of the second embodiment.

FIG. 9 is a conceptual diagram illustrating an example of a service provided by the service providing system according to the third embodiment.

FIG. 10 is a flowchart illustrating exemplary operation of the robot of the third embodiment.

FIG. 11 is a conceptual diagram illustrating an example of a service provided by the service providing system according to the fourth embodiment.

FIG. 12 is a flowchart illustrating exemplary operation of the robot of the fourth embodiment.

FIG. 13 is a diagram illustrating an example of a tidying service of a target area according to the fourth embodiment.

FIG. 14 is a diagram illustrating a state in which liquid has spilled on the floor in the target area of the fourth embodiment.

FIG. 15 is a diagram illustrating an example of a specific area according to the fourth embodiment.

FIG. 16 is a flowchart illustrating an example of the operation of the robot according to the fifth embodiment.

FIG. 17 is a diagram illustrating an example of service provision by the robot of the fifth embodiment.

### DESCRIPTION OF EMBODIMENTS

Hereinafter, an information processing device, a robot, a service providing system, an information processing method, and a program according to embodiments will be described in detail with reference to the drawings.

### First Embodiment

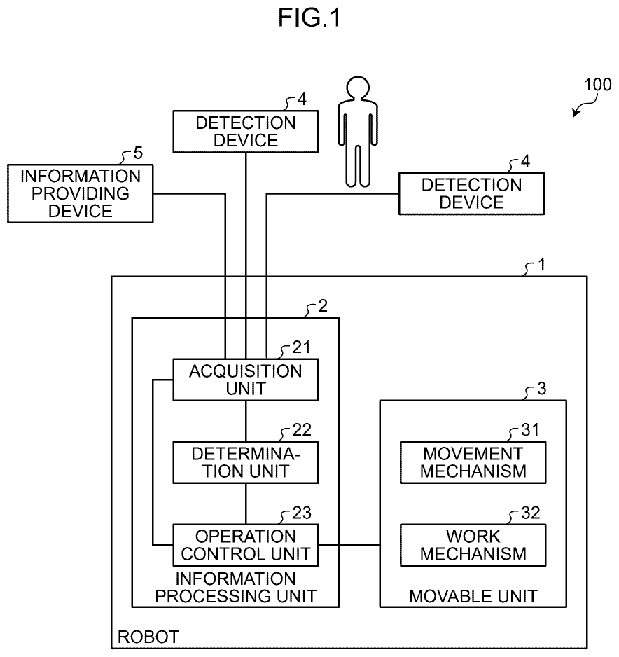

FIG. 1 is a diagram illustrating an exemplary configuration of a service providing system according to the first embodiment. The service providing system 100 of the present embodiment includes a robot 1 capable of providing a service to a user, a detection device 4 that detects user information including a state of the user and/or an environment around the user, and an information providing device 5 that provides the user information. Although FIG. 1 illustrates two types of acquisition sources: the detection device 4 and the information providing device 5, for the robot 1 to acquire the user information, the acquisition source of the user information only needs to include the detection device 4 and/or the information providing device 5, and the service providing system 100 may not include either the detection device 4 or the information providing device 5. Although two detection devices 4 are illustrated in FIG. 1, the number of detection devices 4 in a case where the detection device 4 is used may be one or more, and is not limited to this example.

In the present embodiment, the robot 1 determines a service provision timing by using the user information, and executes an operation of providing a service on the basis of the determined timing. Therefore, the user does not need to instruct the robot 1 to receive the service provided by the robot 1. Therefore, in the present embodiment, it is possible to provide a service to the user by the robot 1 while saving the user's time and effort, and the comfort of the user's life is improved.

The user information is, for example, information including a state of the user and/or an environment around the user. Specifically, the information indicating the state of the user includes, for example, information indicating at least one of a vital sign of the user, a schedule of the user, a moving speed of the user, a position of the user, a state of work performed by the user, a voice of the user, an expression of the user, and the like. The vital of the user is, for example, at least one of a pulse (heart rate), a respiration rate, a blood pressure, a body temperature, and the like. Furthermore, the information indicating the environment around the user is specifically, for example, information indicating at least one of temperature, humidity, weather, a position of an object in an area (for example, an area used or managed by a user) in which the robot 1 provides a service, a time zone, a region (for example, a region where the user currently exists) in which the user receives a service from the robot 1, and the like.

The user information may further include attribute information indicating an attribute of the user. Specifically, the attribute information is, for example, information indicating at least one of the nationality of the user, the language used by the user, the gender of the user, the age of the user, the religious belief of the user, and the like. Note that the specific content of the user information is not limited to the above-described examples. The attribute information may be used to select the type of service to be provided, or may be used to set a service content such as a mode in the service to be provided. Furthermore, the attribute information may be used to determine the timing of service provision together with the state of the user and/or the environment around the user.

The detection device 4 is a sensor that detects user information, and is, for example, a sensor that detects a vital, a camera that captures an image, a video, or the like, a microphone that detects sound, a position sensor that detects a position of an object, or the like. The information providing device 5 is a computer system, and may be a portable terminal that can be carried by a user, a server, or the like, or may be constructed on a cloud system.

In a case where the user information includes vital data that is information indicating a vital of the user, for example, a wearable terminal incorporating a sensor capable of detecting a vital, a non-contact sensor capable of detecting a vital, or the like is used as the detection device 4. Then, vital data indicating the vitals detected by the detection device 4 is transmitted from the detection device 4 to the robot 1.

In a case where the user information includes information indicating the moving speed of the user or information indicating the position of the user, for example, a portable terminal such as a smartphone or a tablet carried by the user is used as the information providing device 5. In this case, the information providing device 5 has a position detecting function of detecting its own position using, for example, a global positioning system (GPS) receiver, and detects its own position. The position detected by the information providing device 5 is used as user information indicating the position of the user carrying the information providing device 5. The position detection is not limited to the example performed using the GPS receiver, and may be performed using a gyro, may be performed using the reception intensity of radio waves transmitted and received with a plurality of other devices, or may be performed by other methods. Note that the information providing device 5 may be a wearable terminal. The moving speed of the user may be calculated by the information providing device 5 using the positions of the user at a plurality of times, and information indicating the moving speed of the user may be transmitted from the information providing device 5 to the robot 1. Alternatively, information indicating the position of the user at a plurality of times may be transmitted from the information providing device 5 to the robot 1 as information indicating the moving speed of the user. In addition, the information providing device 5 may be provided separately from the portable terminal carried by the user, and the information providing device 5 may receive information indicating a position from the portable terminal and transmit the received information to the robot 1 as user information of the user corresponding to the portable terminal. Similarly, the information indicating the moving speed of the user may be transmitted from the portable terminal carried by the user to the robot 1 via the information providing device 5.

Furthermore, in a case where the user information includes information indicating the moving speed of the user or information indicating the position of the user, a position sensor, a camera, or the like may be used as the detection device 4. In a case where a camera is used as the detection device 4, captured data obtained by capturing the user is transmitted from the detection device 4 to the robot 1 as user information. The robot 1 can obtain the position of the user by performing image analysis on the captured data using the position of the detection device 4 and the captured data.

In a case where the user information includes information indicating a schedule of the user, for example, a terminal device used by the user is used as the information providing device 5. The terminal device may be a portable terminal such as a smartphone or a tablet carried by the user, or may be a terminal device installed at home or at a work place. Furthermore, the information providing device 5 may be the information providing device 5 that manages schedules of a plurality of users, and may be, for example, a device constructed on a cloud system. The information providing device 5 manages a schedule input from the user and transmits schedule information indicating the schedule to the robot 1 as user information.

In a case where the user information includes information indicating a state of work performed by the user, for example, a terminal device (computer system) used by the user for work may be used as the information providing device 5, a machine other than the terminal device used by the user for work may be used, or an attendance management system that manages attendance of the user and an entrance/exit system that manages entrance/exit to/from a room area where the user works may be used. The information indicating the state of the work performed by the user may be information indicating that the user has finished the work, information indicating that the user has suspended the work, or both of them.

In a case where the user information includes voice data indicating the voice of the user, for example, a microphone is used as the detection device 4. The microphone may be provided alone, may be built in a terminal device used by the user, or may be provided in the robot 1. In a case where a microphone is used as the detection device 4, voice data acquired by the detection device 4 is transmitted from the detection device 4 to the robot 1. Furthermore, in a case where the user information includes voice data indicating the voice of the user, a terminal device that acquires the voice data of the user may be used as the information providing device 5. In this case, the information providing device 5 acquires voice data from a built-in or external microphone, and transmits the acquired voice data to the robot 1.

In a case where the user information includes information indicating the expression of the user, for example, a camera is used as the detection device 4. The camera may be provided alone, may be built in a terminal device used by the user, or may be provided in the robot 1. The face of the user is captured by the camera, and captured data indicating the captured data or video is transmitted from the detection device 4 to the robot 1 as information indicating the expression of the user. Furthermore, in a case where the user information includes information indicating the expression of the user, a terminal device that acquires the captured data of the user may be used as the information providing device 5. In this case, the information providing device 5 acquires captured data from a built-in or external camera, and transmits the acquired captured data to the robot 1.

In a case where the user information includes information indicating a temperature, a thermometer provided in the surroundings of the user is used as the detection device 4, and in a case where the user information includes information indicating humidity, a hygrometer provided in the surroundings of the user is used as the detection device 4. The surroundings of the user may be, for example, a room of the user, a building where the user exists, or a region such as a municipality where the user exists. In addition, information indicating temperature and/or humidity may be provided from the information providing device 5 that provides weather information. The weather information may be an actual measurement value or a forecast value, but is desirably information at a time close to a time point at which the user information is acquired. In a case where the user information includes information indicating weather, the information is provided from the information providing device 5 that provides weather information, for example.

In a case where the user information indicates the position of an object in an area in which the robot 1 provides a service, for example, a camera that captures an image of the area is used as the detection device 4. In a case where the user information includes information indicating a time zone (for example, information indicating a time zone corresponding to the current time, such as whether the current time is day or night), the robot 1 may acquire the information indicating the time zone from a built-in clocking unit (not illustrated), or may acquire the information indicating the time zone from the information providing device 5.

In a case where the user information includes information indicating a region where the user receives a service from the robot 1, the robot 1 may acquire its own position from a built-in position detection unit (not illustrated), and obtain the information by using the acquired position information and map information to acquire the information. Note that the information indicating the region where the user receives the service from the robot 1 may be used when acquiring the temperature, humidity, and weather from the information providing device 5. Note that the region may be a municipality or a prefecture, may be a country, or may be other than these.

In a case where the user information includes attribute information, the information may be input to the information providing device 5 by the user and transmitted from the information providing device 5 to the robot 1. Alternatively, an acquisition unit 21 of an information processing unit 2 to be described later may also have a function as an input reception means and receive an input of the information from the user. Note that the above-described region may be treated as the attribute information.

The method for acquiring the user information described above is an example, and a specific means for acquiring the user information is not limited to the example described above.

Note that the number of users of the robot 1 may be one or more. For example, in a case where the robot 1 is used at home, all the family members may be users, and in a case where the robot 1 is used at a workplace, employees belonging to the workplace to which the service is provided may be users, or all the people existing in the workplace may be users. In a case where there are a plurality of users, the attribute information may be set for each user, or only items common to all users may be set. For example, in a case where the attribute information is set for each user and the robot 1 provides a drink to a plurality of users, the robot 1 may identify each user to whom a drink is to be provided by using captured data or the like, and provide a drink while speaking to the user in the language used by the user on the basis of the attribute information corresponding to the identified user. That is, the robot 1 may determine the language used by the robot 1 in the service on the basis of the information indicating the language used by the user. Alternatively, in a case where the attribute information is set as an item common to all users, and the common item includes a language used by the users, when the robot 1 provides drinks to a plurality of users, the robot 1 may provide drinks while speaking to all the users to whom drinks are to be provided in the same language on the basis of the attribute information without identifying the users.

As illustrated in FIG. 1, the robot 1 includes the information processing unit 2 that is an information processing device, and a movable unit 3 that executes a service. The robot 1 provides a service to the user by operating the movable unit 3. The service provided by the robot 1 is a service for performing work involving movement. For example, the service is at least one of, but not limited to, housework, various works in an office, and the like, and provision of food and drink. The robot 1 may be a robot that provides a specific service, or may be a general-purpose robot that can provide a plurality of types of services.

The information processing unit 2 is an information processing device that controls the robot 1. The information processing unit 2 includes the acquisition unit 21, a determination unit 22, and an operation control unit 23. The acquisition unit 21 acquires the user information and outputs the acquired user information to the determination unit 22. For example, the acquisition unit 21 acquires the user information by receiving the user information from the detection device 4 and/or the information providing device 5. As described above, the acquisition unit 21 may also have a function as an input reception means and receive an input of user information from the user.

The determination unit 22 determines a timing to provide a service by using the user information received from the acquisition unit 21, and instructs the operation control unit 23 to start providing a service at the determined timing. For example, in a case where the user information satisfies a predetermined condition or an index calculated using the user information satisfies a predetermined condition, the determination unit 22 determines to execute service provision. In this case, the timing at which the user information satisfies the predetermined condition or the timing at which the index calculated using the user information satisfies the predetermined information is the timing to execute the provision of the service (the timing to start the provision of the service).

The operation control unit 23 generates a command for providing a service on the basis of an instruction from the determination unit 22, and outputs the generated command to the movable unit 3. That is, the operation control unit 23 generates a command for the robot 1 to provide a service at the timing based on the timing determined by the determination unit 22, and outputs the generated command to the movable unit 3. The movable unit 3 performs an operation according to the command, so that the service is provided to the user. Note that “output to the movable unit 3” is not limited to a case of direct output from the operation control unit 23 in the robot 1 to the movable unit 3, but also includes a case of transmission via another functional unit and/or another device, such as a case of output to the movable unit 3 via a functional unit having a transmission/reception function and a case of transmission to the movable unit via another device. Note that the operation control unit 23 controls the operation of the movable unit 3 even during the execution of the service.

The movable unit 3 includes a drive mechanism that moves the position of the robot 1, that is, a movement mechanism 31 that is a mechanism for the robot 1 to self-propel, and a work mechanism 32 that is a drive mechanism that executes work for providing a service. The movement mechanism 31 may be, for example, a wheel-type movement mechanism including a wheel and a drive unit that drives the wheel, or may be a crawler-type movement mechanism including a crawler and a drive unit that drives the crawler. When the robot 1 is a humanoid robot or a multi-legged robot, the movement mechanism 31 may be a movement mechanism that enables the robot 1 to walk by including two or more legs and a drive unit that drives the legs. The movement mechanism 31 is not limited thereto, and may have any configuration.

The movement mechanism 31 includes, for example, a sensor such as a camera, an infrared sensor, an ultrasonic sensor, or a light detection and ranging (LIDAR). The operation control unit 23 generates a command for controlling the operation of the movement mechanism 31 using the data acquired by the sensor, and the movement mechanism 31 operates on the basis of the command. The destination of the movement is determined by the operation control unit 23 according to the content of the service. As a result, the robot 1 can autonomously travel.

The work mechanism 32 is, for example, a manipulator, but is not limited thereto. The manipulator includes, for example, an arm having one or more joints and a hand (also referred to as an end effector) connected to a distal end of the arm and capable of gripping an object. The work mechanism 32 may include two or more manipulators. The work mechanism 32 may be a combination of a manipulator and a component dedicated to specific work. The component dedicated to specific work may be, for example, a component dedicated to wiping, a component dedicated to sweeping, a component for sucking dust, a component having a function as a coffee maker, or other components.

The work mechanism 32 includes, for example, an arm tip camera attached to the periphery of the hand. In the robot 1, the operation control unit 23 generates a command for controlling the operation of the work mechanism 32 using the data acquired by the arm tip camera, and the work mechanism 32 operates on the basis of the command. The operation control unit 23 determines the position and posture of the hand according to the content of the work corresponding to the service, and finely adjusts the position and posture of the hand based on the data acquired by the arm tip camera.

Note that the operation of the movement mechanism 31 and the work mechanism 32 by the operation control unit 23 may be controlled with any method, and is not limited to the above-described example. Furthermore, here, an example has been described in which the operation control unit 23 also controls the movement mechanism 31 and the work mechanism 32 during operation. However, the operation control unit 23 may only give an instruction to start the operation corresponding to the service, and the control of the movement mechanism 31 and the work mechanism 32 after the start of the operation may be performed by a control unit (not illustrated) in the movable unit 3.

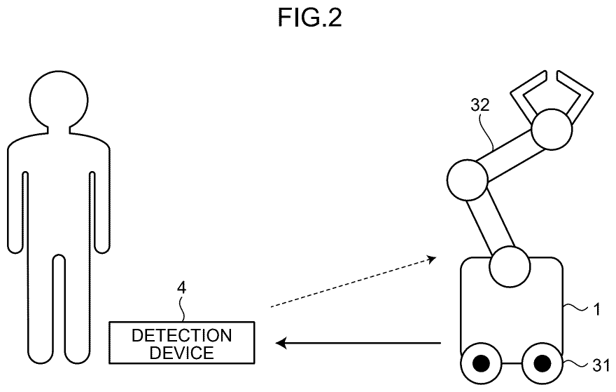

Next, the operation of the robot 1 of the present embodiment will be described. FIG. 2 is a diagram schematically illustrating service provision by the robot 1 of the present embodiment. In the example illustrated in FIG. 2, the user information is acquired by the detection device 4, and the acquired user information is transmitted to the robot 1 as indicated by a broken line in FIG. 2. Note that the communication line between the detection device 4 and the robot 1 may be a wired line, a wireless line, or a mixture thereof. Here, it is assumed that the robot 1 moves to the user and provides a service, and when the information processing unit 2 of the robot 1 determines to provide a service on the basis of the user information, the information processing unit 2 of the robot 1 instructs the movement mechanism 31 to move to the user and perform an operation corresponding to the service. As a result, the robot 1 moves to the user by the movement mechanism 31 and provides a service by the work mechanism 32. As a result, the user can receive the provision of the service from the robot 1 without instructing the robot 1 to execute the operation. Furthermore, the robot 1 may provide a service even in a case where there is an explicit instruction to request execution of service provision from the user.

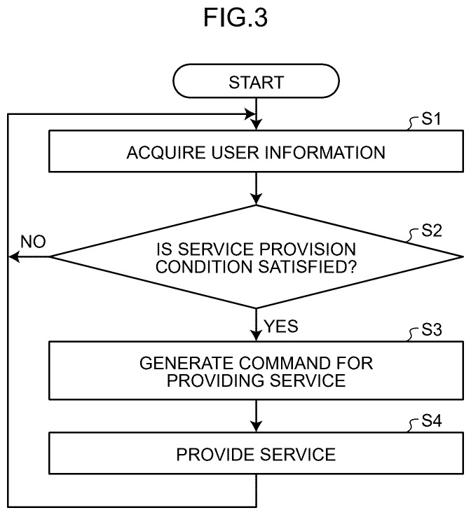

FIG. 3 is a flowchart illustrating exemplary operation of the robot 1 of the present embodiment. The information processing unit 2 of the robot 1 acquires user information (step S1). Specifically, the acquisition unit 21 acquires the user information by receiving the user information from the detection device 4 and/or the information providing device 5, and outputs the acquired user information to the determination unit 22. For example, the detection device 4 and/or the information providing device 5, which are devices from which the user information is transmitted, may voluntarily and periodically transmit the user information. Alternatively, the acquisition unit 21 may periodically request a device from which the user information is transmitted to acquire the user information, and the device from which the user information is transmitted may transmit the user information as a response to the request. Note that, in a case where the attribute information is included in the user information, the acquisition unit 21 may receive an input of the attribute information from the user. Since the same attribute information is used until the attribute information is changed after being set once, the attribute information may be held by the determination unit 22 or may be stored in a storage unit (not illustrated) without being periodically acquired.

Next, the information processing unit 2 of the robot 1 determines whether a service provision condition is satisfied (step S2). Specifically, the determination unit 22 determines whether a predetermined service provision condition is satisfied using the user information received from the acquisition unit 21. The service provision condition is a condition regarding user information or an index calculated using the user information. For example, a condition that a service of providing a drink is provided when the temperature exceeds a threshold is set as the service provision condition. In addition, for example, a condition that a service of removing (returning to the original position) a specific object when the position of the specific object in the room designated in advance moves from the reference position and stays at the destination position for a certain period of time or more is provided is set as the service provision condition. In this case, the index calculated using the user information is the time during which the user stays at the destination position. Furthermore, the reference position may be determined in advance, or the determination unit 22 may learn the reference position using the captured data acquired by the detection device 4. When the robot 1 can provide a plurality of types of services, a service provision condition is determined for each service (for each type of service).

Furthermore, a plurality of types of information may be used as the user information, and the service provision condition may be defined as a combination of conditions regarding each type of user information. For example, a condition that a service of providing a drink is provided when the temperature exceeds a temperature threshold and the humidity exceeds a humidity threshold may be defined as the service provision condition. Alternatively, a condition that a condition that the temperature exceeds the temperature threshold and/or a condition that the humidity exceeds the humidity threshold is satisfied may be defined as the service provision condition. As described above, in a case where the service provision condition is a combination of a plurality of conditions, the service provision condition may be defined as an AND condition of the plurality of conditions or may be defined as an OR condition. In addition, in a case where the service provision condition is a combination of three or more conditions, the service provision condition may be a combination of an AND condition and an OR condition.

In addition, the service provision condition may include a condition related to a time for prohibiting the execution of the service or a time for permitting the execution of the service (date and time, time zone, etc.). For example, a condition regarding a time for prohibiting the execution of the service or a time for permitting the execution of the service may be determined, such as permitting the execution of the service only on weekdays, permitting the execution of the service only from 8:00 to 17:00, or prohibiting the execution of the service from 12:00 to 13:00.

Furthermore, a time for prohibiting the execution of the service or a time for permitting the execution of the service may be determined according to the user information. For example, the determination unit 22 may set a permitted time zone, which is a time zone in which the provision of the service is permitted, on the basis of the information indicating the region where the user exists, and may instruct the operation control unit 23 to generate a command for providing the service in a case where the timing of providing the service determined by the user information other than the region is within the permitted time zone. For example, a time during which eating and drinking is prohibited or the like may be determined depending on a region, a faith, or the like. In such an example, as the service provision condition related to the service of the food and drink provision, for example, a condition that both of a first condition related to the temperature and a second condition that the service is provided (service provision is executed) at a time when eating and drinking is not prohibited in a case where the region in the user information is a region where a time zone in which eating and drinking is prohibited is provided is satisfied is set. Accordingly, even when the first condition is satisfied, the determination unit 22 determines that the service provision condition is not satisfied when the second condition is not satisfied. In addition, conversely, for a service required to be provided only in a specific time zone, a condition for permitting execution of the service may be defined as a service provision condition regarding the service. Note that, here, the condition according to the region has been described as an example. However, the present invention is not limited to this, and a condition regarding a time for prohibiting the execution of the service or a time for permitting the execution of the service may be included with respect to other user information such as the user's nationality, the user's religion, and the user's age. Note that the specific example of the service provision condition is not limited to the above-described example, and the index is also not limited to the above-described example.

When the service provision condition is not satisfied (No in step S2), the processing from step S1 is repeated. When the service provision condition is satisfied (Yes in step S2), the information processing unit 2 of the robot 1 generates a command for providing a service (step S3). Specifically, when the determination unit 22 determines that the service provision condition is satisfied, the determination unit generates instruction information giving an instruction to start service provision, and outputs the generated instruction information to the operation control unit 23. The operation control unit 23 generates a command for providing a service on the basis of the instruction information, and outputs the generated command to the movable unit 3. In a case where the robot 1 can provide a plurality of types of services, the determination unit 22 also includes information specifying the type of service to be provided in the instruction information.

Furthermore, when determining that the service provision condition is satisfied, the determination unit 22 may determine the content of the service such as the mode and the object in the service on the basis of the user information. For example, regarding a service of providing food and drink, setting contents according to the temperature are set as the setting information such that, in a case where the temperature exceeds T₁ degrees and is less than T₂ (T₂>T₁) degrees, a cold drink is carried to the user, and in a case where the temperature is T2 degrees or more, ice is carried to the user in addition to the drink. Then, the determination unit 22 may determine the object to be provided to the user in the service by using the temperature in the user information and the setting information. Furthermore, in a case where the robot 1 can utter a plurality of languages and a mode of the language (language mode) can be set, the determination unit 22 may set the language mode when the robot 1 utters according to the language (language used by the user) in the user information. Furthermore, the determination unit 22 may estimate the user's emotion on the basis of the user information, and determine the content of the service on the basis of the estimated emotion.

After step S3, the robot 1 provides a service (step S4), and the processing from step S1 is repeated. Specifically, in step S4, the movable unit 3 starts operation in response to a command received from the operation control unit 23, so that the service is provided to the user. Note that the robot 1 provides a service using the movable unit 3, but may be able to provide a service by transmitting a signal. For example, in a case where the temperature around the user is equal to or higher than a certain value, the cooling operation of the air conditioner (air conditioner) in the room where the user is present may be performed by providing a cold drink and pressing a switch of the air conditioner, or the cooling operation of the air conditioner may be performed by providing a cold drink and transmitting a signal for causing the air conditioner to perform the cooling operation. As described above, when operating any device for providing a service, the robot 1 may operate the input means, the operation screen, or the like using the movable unit 3 instead of the user, Or may transmit a signal giving an instruction to start the operation to the device.

Furthermore, the user information may be used for controlling the operation of the robot 1 while the robot 1 is performing an operation of providing a service. For example, the detection device 4 may include a camera, and the operation control unit 23 may determine the state of the route to the user (for example, unevenness, presence or absence of a sharp curve, and the like) on the basis of the captured data captured by the camera, and control the movable unit 3 to move via a route in a good condition so that the robot 1 can approach the user quietly.

In the exemplary configuration illustrated in FIG. 1, the determination unit 22 that determines the provision timing of the service is provided in the robot 1, but the determination unit 22 may be provided separately from the robot 1. That is, in FIG. 1, the information processing unit 2 which is an information processing device is provided in the robot 1, but an information processing device may be provided separately from the robot 1, and the information processing device may have at least some of the functions of the information processing unit 2.

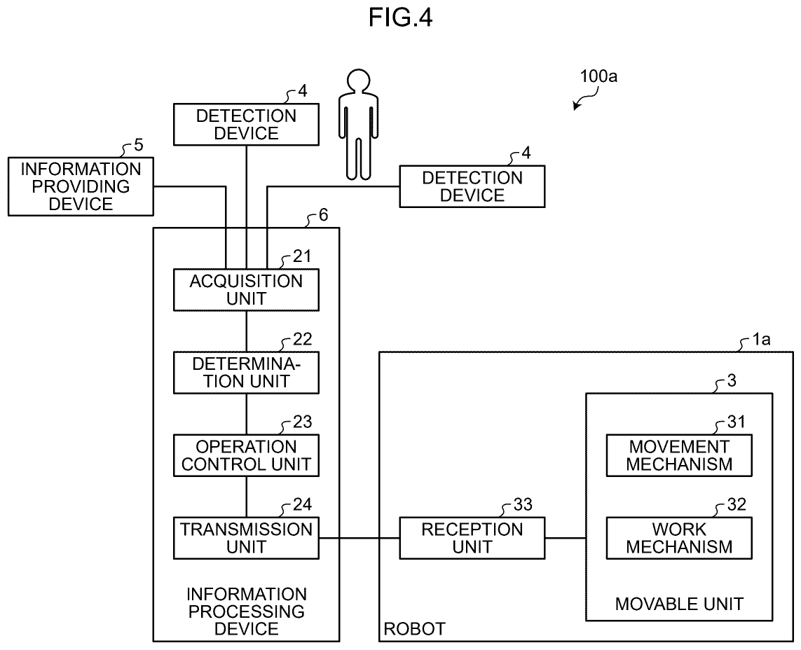

FIG. 4 is a diagram illustrating another exemplary configuration of the service providing system according to the present embodiment. In the example illustrated in FIG. 4, the service providing system 100a includes an information processing device 6 and a robot la instead of the robot 1 in FIG. 1. Components having the same functions as those in FIG. 1 are denoted by the same reference signs as in FIG. 1, and redundant explanations are omitted.

In the exemplary configuration illustrated in FIG. 4, the information processing device 6 includes the acquisition unit 21, the determination unit 22, and the operation control unit 23 in the information processing unit 2 illustrated in FIG. 1. The information processing device 6 further includes a transmission unit 24 that transmits a command generated by the operation control unit 23 to the robot 1a. The robot 1a includes the movable unit 3 similar to the example illustrated in FIG. 1, and further includes a reception unit 33 that receives a command from the information processing device 6. The reception unit 33 outputs the received command to the movable unit 3. As a result, the movable unit 3 performs an operation according to the command, and a service is provided by the movable unit 3 similarly to the exemplary configuration illustrated in FIG. 1. In the example illustrated in FIG. 4, the information processing device 6 also controls the movable unit 3 during execution of the service after the start of service provision.

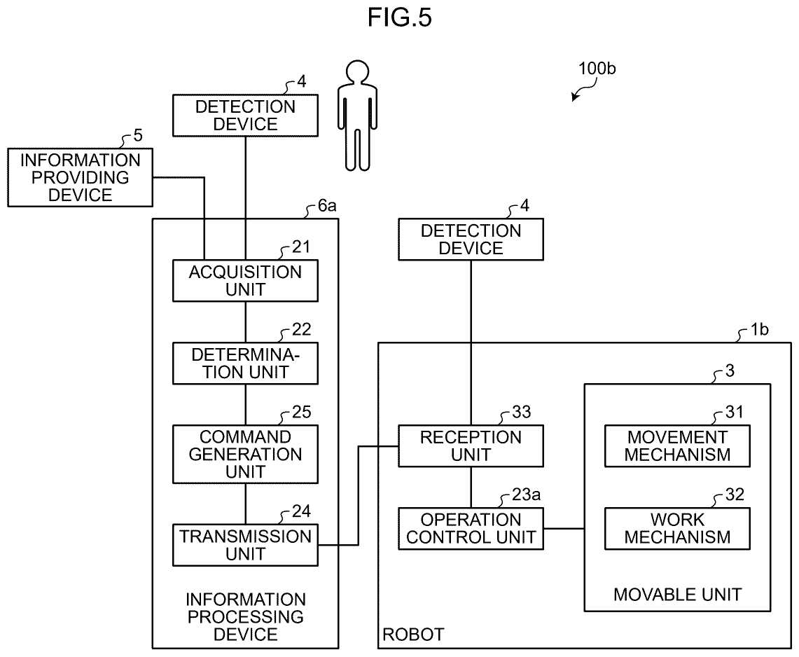

FIG. 5 is a diagram illustrating another exemplary configuration of the service providing system according to the present embodiment. In the example illustrated in FIG. 5, the service providing system 100b includes an information processing device 6a and a robot 1b instead of the robot 1 in FIG. 1. Components having the same functions as those in FIG. 1 are denoted by the same reference signs as in FIG. 1, and redundant explanations are omitted.

In the exemplary configuration illustrated in FIG. 5, the information processing device 6a includes the acquisition unit 21 and the determination unit 22 in the information processing unit 2 illustrated in FIG. 1. The information processing device 6a further includes a command generation unit 25 having a function of generating a command giving an instruction to execute a service (instruction to start service provision) among functions in the operation control unit 23 illustrated in FIG. 1, and the transmission unit 24 that transmits the instruction generated by the command generation unit 25 to the robot 1b. The robot 1b includes the movable unit 3 similar to the example illustrated in FIG. 1, and further includes the reception unit 33 that receives a command from the information processing device 6a, and an operation control unit 23a that controls the operation of the movable unit 3 during the execution of the service. The reception unit 33 outputs the received command to the operation control unit 23a. Upon receiving the command from reception unit 33, operation control unit 23a controls the movable unit 3 to perform an operation for providing a service based on the received command. As a result, the movable unit 3 can start an operation according to the command generated by the information processing device 6a, and a service is provided by the movable unit 3 similarly to the exemplary configuration illustrated in FIG. 1.

As described above, in the example illustrated in FIG. 5, the command to start the provision of the service is generated by the command generation unit 25, and the control of the movable unit 3 during the execution of the service after the start of the provision of the service is performed by the operation control unit 23a of the robot 1b. In other words, the operation control unit 23 illustrated in FIGS. 1 and 4 has both the function of the command generation unit 25 illustrated in FIG. 5 and the function of the operation control unit 23a illustrated in FIG. 5. That is, in the exemplary configuration illustrated in FIGS. 1 and 4, the operation control unit 23 is also the command generation unit 25.

Note that the exemplary configurations illustrated in FIGS. 4 and 5 are examples, and it is sufficient if the robot includes the movable unit 3 and the information processing device generates a command for giving an instruction to start service provision, and the separation of the functions of each device is not limited to the examples illustrated in FIGS. 4 and 5. For example, the operation control unit 23a in the exemplary configuration of FIG. 5 may be provided in a device different from the information processing device 6a and the robot 1b. Furthermore, the operation control unit 23a may be provided in the movable unit 3.

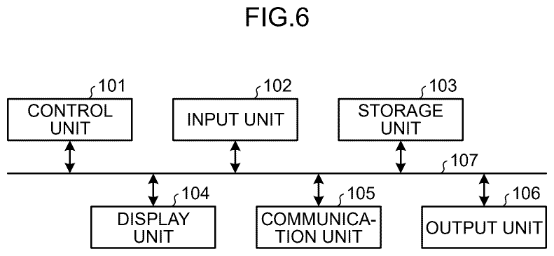

Next, a hardware configuration of the information processing device (the information processing unit 2 and the information processing devices 6 and 6a) according to the present embodiment will be described. In the information processing device according to the present embodiment, a program (computer program) describing the processes in the information processing device is executed on a computer system, so that the computer system functions as the information processing device. FIG. 6 is a diagram illustrating an exemplary configuration of a computer system that implements the information processing device according to the present embodiment. As illustrated in FIG. 6, this computer system includes a control unit 101, an input unit 102, a storage unit 103, a display unit 104, a communication unit 105, and an output unit 106, which are connected to one another via a system bus 107.

In FIG. 6, the control unit 101 is, for example, a processor such as a central processing device (CPU), and executes a program describing the processes in the information processing device according to the present embodiment. The input unit 102 includes, for example, a keyboard, a mouse, and the like, and is used by the user of the computer system to input various types of information. The storage unit 103 includes various types of memories such as a random access memory (RAM) and a read only memory (ROM) and a storage device such as a hard disk. The storage unit 103 stores, for example, programs to be executed by the control unit 101 and necessary data obtained during processing. The storage unit 103 is also used as a temporary storage area for programs. The control unit 101 and the storage unit 103 constitute processing circuitry, for example. The processing circuitry may be one circuit or a plurality of circuits. The display unit 104 includes a display, a liquid crystal display (LCD) panel, or the like, and displays various screens to the user of the computer system. Note that the input unit 102 and the display unit 104 may be integrated, and may be implemented by a touch panel or the like. The communication unit 105 is a receiver and a transmitter that perform communication processing. The output unit 106 is a printer, a speaker, or the like. Note that FIG. 6 is an example, and the configuration of the computer system is not limited to the example illustrated in FIG. 6. For example, the computer system may not include one or more of the input unit 102, the display unit 104, and the output unit 106.

Here, an example of how the computer system operates until the program according to the present embodiment becomes executable will be described. In the computer system having the above-mentioned configuration, for example, the program is installed on the storage unit 103 from a compact disc (CD)-ROM or digital versatile disc (DVD)-ROM set in a CD-ROM drive or DVD-ROM drive (not illustrated). Then, when the program is executed, the program read from the storage unit 103 is stored in the main storage area of the storage unit 103. In this state, the control unit 101 executes the processes as the information processing device according to the present embodiment in accordance with the program stored in the storage unit 103.

In the above description, the program describing the processes in the information processing device is provided using a CD-ROM or DVD-ROM as a recording medium. Alternatively, the program may be provided by a transmission medium such as the Internet via the communication unit 105 according to the configuration of the computer system, the capacity of the program, and the like.

The program of the present embodiment causes, for example, the information processing unit 2, which is a computer system that controls the robot 1, to execute a step of acquiring user information, a step of determining a timing to provide a service using the user information, and a step of generating a command for providing a service at the timing determined by the robot 1 on the basis of the determined timing.

The determination unit 22 and the operation control unit 23 illustrated in FIG. 1 are implemented by the control unit 101 illustrated in FIG. 6 executing a program stored in the storage unit 103 illustrated in FIG. 6. The storage unit 103 illustrated in FIG. 6 is also used to implement the determination unit 22 and the operation control unit 23 illustrated in FIG. 1. The acquisition unit 21 illustrated in FIG. 1 is implemented by the communication unit 105 illustrated in FIG. 6. In order to implement the acquisition unit 21 illustrated in FIG. 1, the input unit 102 may be further used. Furthermore, the control unit 101 and the storage unit 103 may be further used to implement the acquisition unit 21 illustrated in FIG. 1.

The determination unit 22 and the operation control unit 23 illustrated in FIG. 4 are implemented by the control unit 101 illustrated in FIG. 6 executing a program stored in the storage unit 103 illustrated in FIG. 6. The storage unit 103 illustrated in FIG. 6 is also used to implement the determination unit 22 and the operation control unit 23 illustrated in FIG. 4. The acquisition unit 21 and the transmission unit 24 illustrated in FIG. 4 are implemented by the communication unit 105 illustrated in FIG. 6. In order to implement the acquisition unit 21 illustrated in FIG. 4, the input unit 102 may be further used. Furthermore, the control unit 101 and the storage unit 103 may be further used to implement the acquisition unit 21 illustrated in FIG. 4.

The determination unit 22 and the command generation unit 25 illustrated in FIG. 5 are implemented by the control unit 101 illustrated in FIG. 6 executing a program stored in the storage unit 103 illustrated in FIG. 6. The storage unit 103 illustrated in FIG. 6 is also used to implement the determination unit 22 and the command generation unit 25 illustrated in FIG. 5. The acquisition unit 21 and the transmission unit 24 illustrated in FIG. 5 are implemented by the communication unit 105 illustrated in FIG. 6. In order to implement the acquisition unit 21 illustrated in FIG. 5, the input unit 102 may be further used. Furthermore, the control unit 101 and the storage unit 103 may be further used to implement the acquisition unit 21 illustrated in FIG. 5. Furthermore, the reception unit 33 and the operation control unit 23a of the robot 1b illustrated in FIG. 5 are also implemented by, for example, a computer system, and the operation control unit 238 is implemented by the control unit 101 illustrated in FIG. 6 executing a program stored in the storage unit 103 illustrated in FIG. 6. The storage unit 103 illustrated in FIG. 6 is also used to implement the operation control unit 23a.

Furthermore, each of the information processing device 6 illustrated in FIG. 4 and the information processing device 6a illustrated in FIG. 5 may be implemented by a plurality of computer systems. For example, the information processing device 6 illustrated in FIG. 4 and the information processing device 6a illustrated in FIG. 5 may be implemented by a cloud system.

As described above, in the present embodiment, the information processing device (information processing unit 2, information processing device 6 or 6a) determines a timing to provide a service using the user information, and generates a command for causing the movable unit 3 of the robot (robot 1, 1a, or 1b) to execute an operation of providing a service on the basis of the determined timing. Therefore, the user does not need to instruct the robot to receive the service provided by the robot. Therefore, in the present embodiment, it is possible to provide a service to the user by the robot 1 while saving the user's time and effort. This improves the comfort of the user's life.

### Second Embodiment

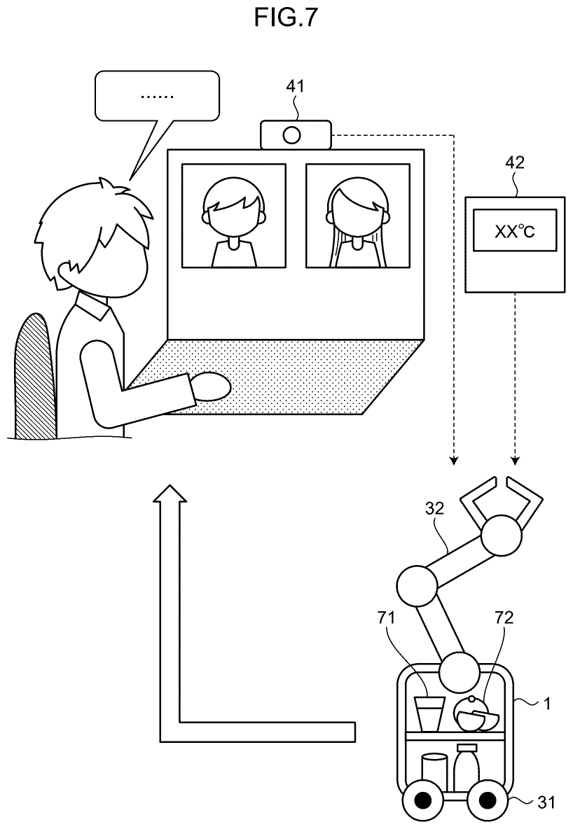

FIG. 7 is a conceptual diagram illustrating an example of a service provided by the service providing system 100 according to the second embodiment. In the present embodiment, a specific example of a service provided by the robot 1 described in the first embodiment and a service provision condition will be described. A configuration of the service providing system 100 of the present embodiment and a configuration of each device constituting the service providing system 100 are similar to those of the first embodiment. Here, the service providing system 100 having the configuration illustrated in FIG. 1 of the first embodiment will be described as an example, but the operation of the present embodiment can be similarly applied to the exemplary configuration illustrated in FIG. 4 or 5 of the first embodiment. As described in the first embodiment, the function of each device is not limited to the example illustrated in FIGS. 4 and 5. Components having the same functions as those in the first embodiment are explained by being denoted by the same reference signs as those in the first embodiment. Hereinafter, differences from the first embodiment will be mainly described.

As illustrated in FIG. 7, in the present embodiment, an example in which the robot 1 provides a service on the basis of the amount of utterance made by the user online or face-to-face will be described. Note that FIG. 7 illustrates an example in which the user makes utterance at an online meeting. However, a scene in which the user makes utterance is not limited to this example, and may be, for example, a face-to-face meeting, or may be a scene other than a meeting, such as an online or face-to-face seminar, a lecture, an educational event, or a meeting.

In the present embodiment, the robot 1 can provide a drink carry service for carrying a drink 71 to the user. Furthermore, the robot 1 may also carry food such as a fruit 72 to the user. In the present embodiment, the determination unit 22 determines a timing at which the drink carry service is provided based on the amount of utterance of the user.

In the example illustrated in FIG. 7, a specific example of the detection device 4 described in the first embodiment is a microphone-equipped Web camera 41 used by the user for an online meeting, and voice data indicating a voice detected by the microphone-equipped Web camera 41 is acquired by the acquisition unit 21 in the information processing unit 2 of the robot 1. The voice data is an example of utterance information which is a detection result of the utterance of the user, and for example, may be transmitted from the microphone-equipped Web camera 41 to the robot 1 via the computer system used by the user for the online meeting, or may be transmitted from the microphone-equipped Web camera 41 to the robot 1 via the computer system used by the user for the online meeting and a network (for example, a wide area network (WAN) such as the Internet, a local area network (LAN), or the like.).

Note that, in FIG. 7, the microphone-equipped Web camera 41 is illustrated as a specific example of the detection device 4, but the detection device 4 that acquires voice data is not limited thereto, and may be a microphone built in a computer system used by the user for an online meeting, a headset connected to the computer system, or a microphone connected to the computer system. Further, a microphone may be mounted on the robot 1, and the microphone may be used as the detection device 4. The computer system used by the user for the online meeting is not limited to a laptop computer system, and may be a desktop computer system, a smartphone, a tablet, or the like. In addition, although FIG. 7 illustrates an example in which the user makes utterance using the computer system, a phone system may be used as the detection device 4 in a case where the phone system is a telephone meeting system or a phone system such as a telephone and voice data can be acquired from the phone system. Furthermore, in the case of a face-to-face meeting or the like, a microphone installed in the surroundings of the user, a microphone incorporated in a computer system operated by the user, a microphone externally attached to the computer system operated by the user, a microphone mounted on the robot 1, or the like may be used as the detection device 4.

In FIG. 7, a thermometer 42 that acquires the temperature around the user is further used as the detection device 4, but the temperature may be acquired from the information providing device 5 that provides weather information. Furthermore, FIG. 7 illustrates an example in which the voice data and the temperature are acquired as the user information, but the user information is not limited thereto, and may be only the voice data, the voice data and data other than the temperature may be used, or data other than the temperature may be used in addition to the voice data and the temperature.

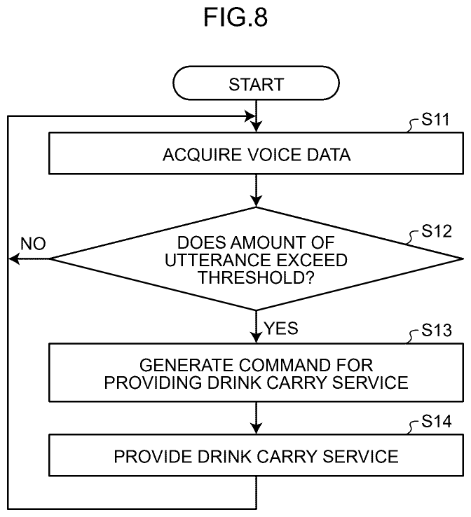

FIG. 8 is a flowchart illustrating exemplary operation of the robot 1 of the present embodiment. The information processing unit 2 of the robot 1 acquires voice data (step S11). Specifically, the acquisition unit 21 acquires voice data of the user from the detection device 4 and/or the information providing device 5, and outputs the acquired voice data to the determination unit 22. Note that FIG. 8 illustrates an example in which voice data is acquired as the user information. However, as described with reference to FIG. 7, temperature may be further acquired as the user information, or data other than the temperature may be acquired.

The information processing unit 2 of the robot 1 determines whether the amount of utterance exceeds a threshold (step S12). Specifically, the determination unit 22 calculates the amount of utterance using the voice data, and determines whether the calculated amount of utterance exceeds the threshold. The amount of utterance may be the total amount of time of utterance or the number of characters uttered. In a case where the number of characters uttered is used as the amount of utterance, the determination unit 22 converts the voice into characters by voice recognition processing and counts the number of characters. The starting point for calculating the amount of utterance may be at the time of carrying a drink to the user last time, that is, at the time of providing a service to the user last time, at the time of starting a meeting, or other times.

In a meeting or the like, the detection device 4 may detect a voice of a person other than the user, but the determination unit 22 may perform speaker identification processing to recognize the voice of the user and calculate the amount of utterance of the user, or may calculate the total amount of utterance of all members in the meeting. The threshold set in the latter case may be a value smaller (lower) than the threshold set in the former case. In the case of performing speaker identification, for example, voice data of the user is learned in advance, and the determination unit 22 performs speaker identification using the learned result. The determination unit 22 may learn speaker identification, or a learning device other than the robot 1 may perform learning and the determination unit 22 may use a result learned by the learning device. Furthermore, in a case where the number of service provision targets is a plurality of persons, the determination unit 22 may perform speaker identification to obtain the sum amount of utterance of the plurality of persons, or may calculate the amount of utterance of each of the plurality of users and determine whether the amount of utterance of one or more users exceeds the threshold. The processing in step S12 is a specific example of processing as to whether the service provision condition in step S2 described in the first embodiment is satisfied. In the present embodiment, the index calculated using the user information is the amount of utterance, and the service provision condition is a condition that the amount of utterance exceeds the threshold.

When the amount of utterance does not exceed the threshold (No in step S12), the processing from step S11 is repeated. When the amount of utterance exceeds the threshold (Yes in step S12), the information processing unit 2 of the robot 1 generates a command for providing a drink carry service (step S13). Specifically, when the determination unit 22 determines that the amount of utterance exceeds the threshold, the determination unit generates instruction information giving an instruction to start provision of the drink carry service, and outputs the generated instruction information to the operation control unit 23. The operation control unit 23 generates a command for providing a service on the basis of the instruction information, and outputs the generated command to the movable unit 3. Furthermore, as illustrated in FIG. 7, the fruit 72 may be provided in addition to a drink, or food other than the fruit 72 may be provided. The position of the user to whom the drink is to be carried may be acquired as the user information or may be set in advance. In a case where the position of the user is set in advance, the setting of the position of the user may be changeable by the user, the operator, or the like.

When determining that the amount of utterance exceeds the threshold, the determination unit 22 may determine the content of the service in the drink carry service on the basis of the user information. For example, as illustrated in FIG. 7, the temperature is also acquired as the user information, and setting contents according to the temperature are set as the setting information such that a cold drink is provided in a case where the temperature exceeds T₁ degrees and is less than T₂ degrees, and ice is provided in a case where the temperature is T₂ degrees or more. In step S11, the temperature may be acquired in addition to the voice data, and the determination unit 22 may determine a drink to be provided to the user in the service by using the temperature in the user information and the setting information. Furthermore, in a case where the robot 1 can utter a plurality of languages and the language mode can be set, the determination unit 22 may also acquire the attribute information as the user information, and set the language mode when the robot 1 carries a drink to the user and speaks to the user according to the language used by the user. In addition, when the robot 1 carries drinks, the robot 1 may carry a plurality of drinks so that the user can select the drinks, or drinks corresponding to the user may be carried. For example, as one item of the attribute information, setting may be enabled on a drink desired to be provided at a meeting, and the drink desired to be provided at the meeting may be set in advance by the user. Accordingly, the determination unit 22 can include, in the instruction information, information designating provision of a drink set in the attribute information.

After step S13, the robot 1 provides the drink carry service (step S14), and the processing from step S11 is repeated. Specifically, in step S14, the movable unit 3 starts operation in response to a command received from the operation control unit 23, so that the drink carry service is provided.

In FIG. 8, an example in which the service provision condition is a condition that the amount of utterance exceeds the threshold has been described, but the service provision condition is not limited to this example. For example, the service provision condition may be a condition that the amount of utterance exceeds the threshold, and then the threshold may be changed according to the temperature. For example, when the temperature is equal to or higher than a predetermined value, the threshold may be set lower than when the temperature is lower than the predetermined value. In addition, the determination unit 22 may determine the content of the service according to the temperature such that, in a case where the temperature is lower than the predetermined value, drinks are carried to the user including a warm drink, and in a case where the temperature is equal to or higher than the predetermined value, only cold drinks are carried to the user. The user information used to determine the content of the service may be humidity, weather, region, or the like, and is not limited to the temperature.

As described above, in the present embodiment, the condition using the amount of utterance is set as the service provision condition. As a result, the user does not need to instruct the robot 1 in order to receive the drink providing service provided by the robot 1. Therefore, in the present embodiment, the user can receive the drink providing service while saving the user's time and effort. For example, in a case where the user gets thirsty due to a large amount of utterance during a meeting, the user can receive a drink providing service without giving an instruction to the robot 1. This improves the comfort of the user's life.

### Third Embodiment

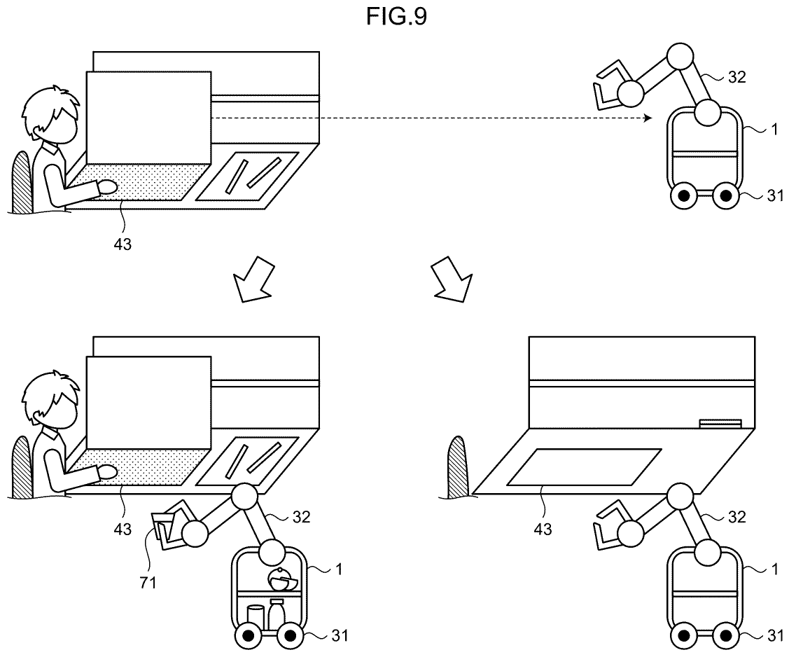

FIG. 9 is a conceptual diagram illustrating an example of a service provided by the service providing system 100 according to the third embodiment. In the present embodiment, a specific example of a service provided by the robot 1 described in the first embodiment and a service provision condition will be described. A configuration of the service providing system 100 of the present embodiment and a configuration of each device constituting the service providing system 100 are similar to those of the first embodiment. Here, the service providing system 100 having the configuration illustrated in FIG. 1 of the first embodiment will be described as an example, but the operation of the present embodiment can be similarly applied to the exemplary configuration illustrated in FIG. 4 or 5 of the first embodiment. As described in the first embodiment, the function of each device is not limited to the example illustrated in FIGS. 4 and 5. Components having the same functions as those in the first embodiment are explained by being denoted by the same reference signs as those in the first embodiment. Hereinafter, differences from the first embodiment will be mainly described.

As illustrated in FIG. 9, in the present embodiment, a personal computer (PC) 43 which is a computer system used by a user is used as the detection device 4. The PC 43 may be considered as the information providing device 5. The information processing unit 2 of the robot 1 acquires information indicating an operating state such as shutdown and transition to sleep of the PC 43 from the PC 43 as user information, and determines a timing of service provision by the robot 1 based on the information acquired from the PC 43.

The information indicating the operating state of the PC 43 is an example of work state information indicating the state of the user's work. The work state information includes end information indicating whether the user work, which is the work of the user, is ended and/or interruption information indicating whether the user work is interrupted. The end information is, for example, shutdown information indicating that the PC 43 has been shut down, and the interruption information is, for example, sleep information indicating that the PC 43 has transitioned to sleep (sleep state). The work state information is not limited thereto, and as described in the first embodiment, the attendance information managed by the attendance management system or the like may be used.

In the example illustrated in FIG. 9, the user is performing work using the PC 43, and when receiving sleep information from the PC 43, the robot 1 determines that the user has interrupted the work, and provides a service (drink carry service service) for providing a drink to the user as illustrated in the lower left of FIG. 9. When the sleep information is not transmitted, the robot 1 can determine that the PC 43 has not transitioned to the sleep state, and when the sleep information is transmitted, the robot 1 can determine that the PC 43 has transitioned to the sleep state (hereinafter, also referred to as sleep).

When the condition for transition to sleep is satisfied, the PC 43 transitions to sleep and transmits a signal indicating the transition to sleep to the robot 1. Note that the PC 43 may transition to sleep in a case where the user makes an input giving an instruction to transition to the sleep, or may transition to the sleep in a case where a predetermined condition such as no input for a certain period of time or more is satisfied.

When shutdown information is received from the PC 43, the robot 1 determines that the user has finished the work, and provides a service of tidying up the user's desk as illustrated in the lower right of FIG. 9. For example, when receiving an input indicating shutdown from the user, the PC 43 starts processing for shutdown and transmits shutdown information indicating shutdown to the robot 1. The signal indicating shutdown is an example of shutdown information.

Note that the PC 43 may periodically transmit information indicating whether it is in a normal state or a sleep state, and this information may be used as the sleep information. In addition, the acquisition unit 21 may periodically inquire of the PC 43 about a current state (whether it is in a normal state, a sleep state, or a shutdown process), and a response to the inquiry from the PC 43 may be used as the sleep information and the shutdown information.

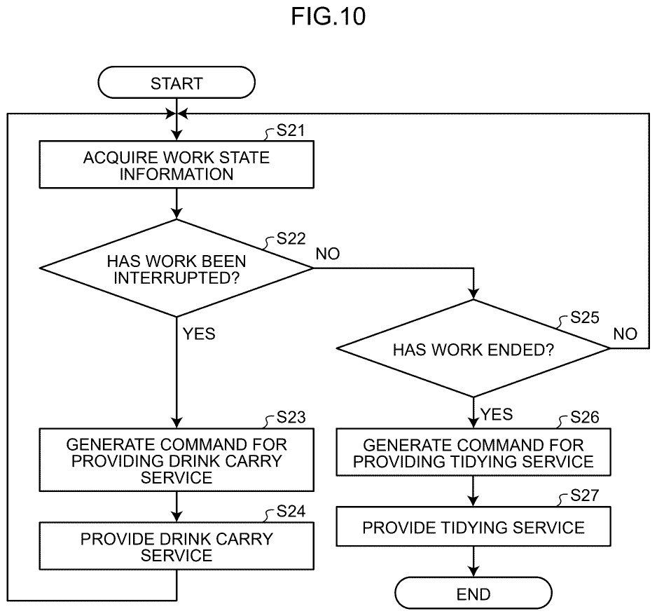

FIG. 10 is a flowchart illustrating exemplary operation of the robot 1 of the present embodiment. The information processing unit 2 of the robot 1 acquires work state information (step S21). Specifically, the acquisition unit 21 acquires the work state information from the detection device 4 and/or the information providing device 5, and outputs the acquired work state information to the determination unit 22.

The information processing unit 2 of the robot 1 determines whether the work has been interrupted (step S22). Specifically, the determination unit 22 determines whether the work state information is information indicating that the user's work has been suspended. The information indicating that the work of the user has been interrupted is, for example, sleep information acquired from the PC 43 as described above.

When the work has been interrupted (Yes in step S22), the information processing unit 2 of the robot 1 generates a command for providing a drink carry service (step S23). Specifically, when the determination unit 22 determines that the work has been interrupted, as in the second embodiment, the determination unit generates instruction information giving an instruction to start provision of the drink carry service, and outputs the generated instruction information to the operation control unit 23. The operation control unit 23 generates a command for providing a service on the basis of the instruction information, and outputs the generated command to the movable unit 3. Furthermore, as in the second embodiment, food may be provided in addition to drinks.

After step S23, the robot 1 provides the drink carry service (step S24), and the processing from step S21 is repeated. Specifically, in step S24, the movable unit 3 starts operation in response to a command received from the operation control unit 23, so that the drink carry service is provided to the user. Note that, in the example illustrated in FIG. 9, the destination of drink carry is the user around the PC 43, and the robot 1 may carry the drink with the position of the PC 43 as a target. When the distance from the PC 43 is within a certain value, the robot 1 may detect the user on the basis of the captured data captured by the camera mounted on the robot 1 and carry the drink to the detected user. Alternatively, at the start of carry or during carry, the user may be detected on the basis of captured data captured by the camera mounted on the PC 43 or a camera mounted around the PC 43, and drinks may be conveyed to the detected user. Furthermore, in a case where a plurality of persons is detected from the captured data, a user registered in advance may be identified from among the plurality of persons, and a drink may be carried to the specified user, or a drink may be provided to all of the plurality of detected persons without identifying the user. In a case of identifying a user registered in advance from among a plurality of persons, for example, the operation control unit 23 learns an image of the user in advance by machine learning or the like.

When the work has not been interrupted (No in step S22), the information processing unit 2 of the robot 1 determines whether the work has ended (step S25). Specifically, the determination unit 22 determines whether the work state information is information indicating that the user's work has ended. The information indicating that the user's work has ended is, for example, shutdown information acquired from the PC 43 as described above.

When the work has not ended (No in step S25), the processing from step S21 is repeated. When the work has ended (Yes in step S25), the information processing unit 2 of the robot 1 generates a command for providing a tidying service (step S26). Specifically, when the determination unit 22 determines that the work has ended, the determination unit generates instruction information giving an instruction to start provision of the tidying service to tidy up the user's desk, and outputs the generated instruction information to the operation control unit 23. The operation control unit 23 generates a command for providing a service on the basis of the instruction information, and outputs the generated command to the movable unit 3.

After step S26, the robot 1 provides the tidying service (step S27), and ends the service provision processing according to the work state of the user. Specifically, in step S27, the movable unit 3 starts operation in response to a command received from the operation control unit 23, so that the tidying service is provided to the user. In the example illustrated in FIG. 9, the object to be tidied up is a desk on which the PC 43 to be tidied up is placed, but the object to be tidied up is not limited thereto. For example, a place where the user tidies up at the end of work may be set in advance.

In the example illustrated in FIG. 10, the processing ends after step S27. However, in a case where a service is provided to a plurality of users, after step S27, the processing from step S21 may be performed with a PC of another user as a monitoring target. In addition, although FIG. 10 illustrates an example in which both a service provided at the time of work interruption and a service provided at the time of work end can be provided, the robot 1 may provide either one of the services. For example, in the case of No in step S22, the processing from step S21 may be repeated, or after step S21, the processing from step S22 may be performed without performing step S25.

The processing in steps S22 and S25 is a specific example of processing as to whether the service provision condition in step S2 described in the first embodiment is satisfied. Services provided at the time of interruption of the user's work and at the time of end of the work are not limited to the examples illustrated in FIGS. 9 and 10, and may be determined in advance. For example, the robot 1 may provide a service of carrying goods for exercise at the time of interruption of work, and in a case where the user works at a workplace, the robot 1 may provide a service of carrying baggage of the user from a locker or the like at the end of work, and a service other than the examples illustrated in FIGS. 9 and 10 may be provided.

As described above, in the present embodiment, the determination unit 22 determines whether the user work has ended on the basis of the end information, and when determining that the user work has ended, the determination unit determines to provide a first service that is a predetermined service performed when the user work has ended, and instructs the operation control unit 23 to generate a command for providing the first service. In addition, the determination unit 22 determines whether the user work has been interrupted on the basis of the interruption information, and when it is determined that the user work has been interrupted, the determination unit determines to provide a second service which is a predetermined service performed when the user work has been interrupted, and instructs the operation control unit 23 to generate a command for providing the second service. For example, the first service includes a service for tidying up the user's desk, and the second service includes a drink carry service.

In addition, the robot 1 may perform both the operation described in the second embodiment and the operation described in the third embodiment. That is, the robot 1 may provide the service described in the second embodiment in a case where the service provision condition is satisfied on the basis of the amount of utterance, and may provide the service described in the present embodiment in a case where the service provision condition is satisfied on the basis of the work state information.

As described above, in the present embodiment, the service provision condition includes the condition that the work state information indicates that the user's work has been interrupted and/or the condition that the work state information indicates that the user's work has ended. As a result, the user can receive provision of a service without giving an instruction to the robot at the time of work interruption, end, or the like. This improves the comfort of the user's life.

### Fourth Embodiment

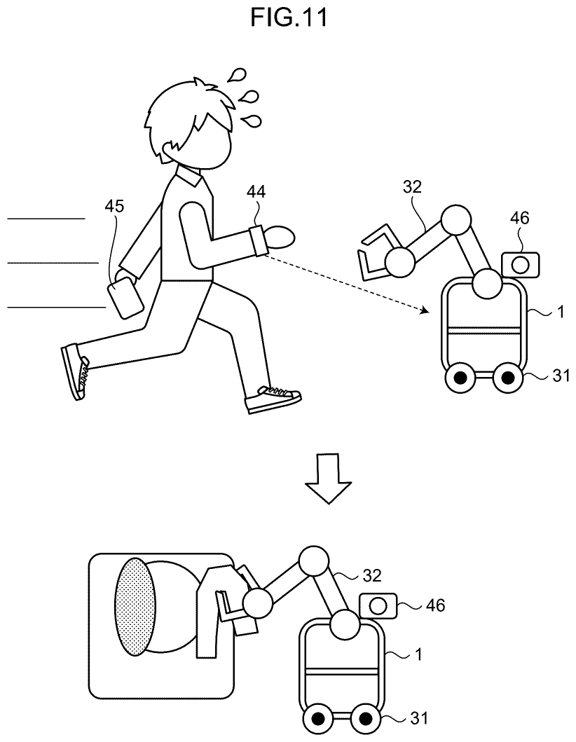

FIG. 11 is a conceptual diagram illustrating an example of a service provided by the service providing system 100 according to the fourth embodiment. In the present embodiment, a specific example of a service provided by the robot 1 described in the first embodiment and a service provision condition will be described. A configuration of the service providing system 100 of the present embodiment and a configuration of each device constituting the service providing system 100 are similar to those of the first embodiment. Here, the service providing system 100 having the configuration illustrated in FIG. 1 of the first embodiment will be described as an example, but the operation of the present embodiment can be similarly applied to the exemplary configuration illustrated in FIG. 4 or 5 of the first embodiment. As described in the first embodiment, the function of each device is not limited to the example illustrated in FIGS. 4 and 5. Components having the same functions as those in the first embodiment are explained by being denoted by the same reference signs as those in the first embodiment. Hereinafter, differences from the first embodiment will be mainly described.

In the present embodiment, when the information processing unit 2 of the robot 1 determines that the user is busy on the basis of the user information, the information processing unit 2 provides a housekeeping service as illustrated in FIG. 11. FIG. 11 illustrates an example in which the robot 1 provides a service for doing laundry washing as the housekeeping service, but the specific content of the housekeeping service is not limited to this example, and may be a service for performing cleaning, cooking, tidying, or the like, or may be other services. In addition, the housekeeping service may be a service including a combination of a plurality of housework tasks such as cleaning and laundry.

In the present embodiment, busyness information indicating a degree of busyness of the user is calculated from user state information indicating a state of the user. The user state information of the present embodiment is an example of user information, and the user state information is information indicating busyness of the user. The user state information of the present embodiment is, for example, information indicating the moving speed of the user. More specifically, the user state information may be, for example, information indicating the position of the user at a plurality of times. For example, as illustrated in FIG. 11, the information indicating the moving speed of the user is acquired by one or more of a wearable terminal 44 that is the detection device 4 and worn by the user, a portable terminal 45 that is the detection device 4 and carried by the user, and the like, and is transmitted to the robot 1. Furthermore, in a case where the robot 1 is present around the user, the information indicating the moving speed of the user may be captured data acquired by the camera 46 mounted on the robot 1 or captured data acquired by another camera (not illustrated).

The determination unit 22 in the information processing unit 2 of the robot 1 calculates the degree of busyness of the user using the user state information. In a case where the degree of busyness exceeds the threshold, the determination unit 22 determines to provide the housekeeping service, and instructs the operation control unit 23 to generate a command for providing the housekeeping service. An example in which the degree of busyness has two levels (binary values): busy or not, will be described, but the degree of business is not limited thereto, and may be indicated in three or more levels. The determination unit 22 acquires the busyness information by calculating the busyness information indicating the degree of busyness based on the moving speed and the correspondence information acquired as the user information. When the information indicating the position of the user at the plurality of times is acquired as the information indicating the moving speed of the user, the determination unit 22 calculates the moving speed using the information indicating the position of the user at the plurality of times, and calculates the busyness information indicating the degree of business based on the calculated moving speed and the correspondence information. As the moving speed, for example, an average speed in a predetermined time can be used, but the moving speed is not limited thereto.

In addition, in a case where the moving speed exceeds the speed assumed as the movement by walking, it is assumed that the user is moving by a vehicle such as a car or an airplane, and the determination of busyness using the moving speed may not be performed. For example, a speed at which the moving speed is faster than a speed assumed as movement by walking may be set as an upper limit value, and when the moving speed exceeds the upper limit value, the determination of busyness using the moving speed may not be performed. Alternatively, the upper limit value of the moving speed may not be set, and the corresponding busyness level may be determined for the range of the moving speed assumed to be moved by the vehicle in the correspondence information.

Furthermore, the user state information may be schedule information registered in the portable terminal 45 or a computer system (not illustrated) other than the portable terminal 45. The schedule information is information indicating the schedule of the user. In this case, for example, the schedule information is transmitted to the robot 1 from the portable terminal 45 which is the information providing device 5 or a computer system (not illustrated) other than the portable terminal 45. For example, the information processing unit 2 of the robot 1 may determine that the user is busy when the number of events registered within a predetermined unit time exceeds a threshold on the basis of the schedule information, or may determine that the user is busy when the idle time between the events is less than the threshold. In addition, for example, the information processing unit 2 of the robot 1 may determine, on the basis of the schedule information, a time zone in which a specific predetermined event is scheduled as a time zone in which the user is busy, or may determine whether the user is busy by a determination method other than these. Similarly to the case of the moving speed, the correspondence between the degree of business and the condition regarding the schedule information (condition regarding the number of events and the like) may be defined as the correspondence information, and the determination unit 22 may calculate the busyness information indicating the degree of busyness using the correspondence information and the schedule information. The determination unit 22 may calculate the busyness information indicating the degree of business by using both the schedule information and the moving speed. In this case, for example, the correspondence between the condition related to the schedule information and the range of the moving speed is determined as the correspondence information for each degree of business. As described above, in the present embodiment, the user information includes the information indicating the busyness of the user, and the information indicating the business of the user includes the information indicating the moving speed of the user and/or the information indicating the schedule of the user.

Furthermore, the determination unit 22 of the information processing unit 2 of the robot 1 may estimate the user's emotion and determine the degree of busyness of the user by further using the estimated emotion. For example, at least one of the user's vital data and the captured data captured by the camera may be included as the user state information, and the determination unit 22 may estimate the user's emotion using the user's vital data and/or the captured data captured by the camera. As a method of estimating the emotion from the user's vital data and/or the captured data captured by the camera, any method may be used. For example, a method of learning a relationship between the user's vital data and/or the captured data captured by the camera and the emotion by machine learning and using a learning result can be used. For example, the determination unit 22 may determine that the user is busy in a case where it is estimated that the moving speed is equal to or higher than the threshold and the user's emotion is in an irritated state. The method of determining busyness using emotions is not limited to this example. In addition, although the emotion is used to determine busyness here, the emotions may be further used in the second and third embodiments. For example, in the second and third embodiments, at the time of providing a drink, in a case where the user feels anger anxiety, a drink that alleviates anxiety, tension, or the like may be provided.

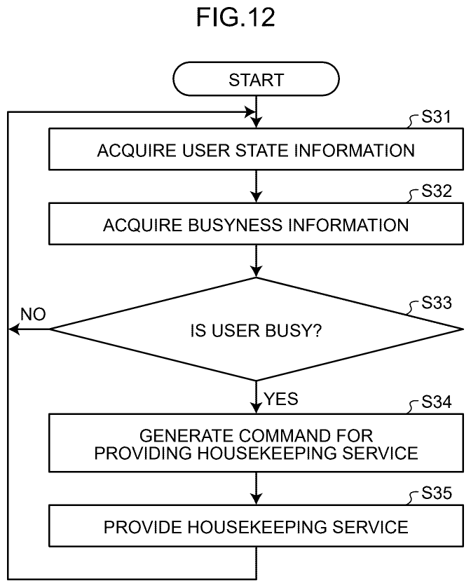

FIG. 12 is a flowchart illustrating exemplary operation of the robot 1 of the present embodiment. The information processing unit 2 of the robot 1 acquires user state information (step S31). Specifically, the acquisition unit 21 acquires the user state information from the detection device 4 and/or the information providing device 5, and outputs the acquired user state information to the determination unit 22.

The information processing unit 2 of the robot 1 acquires busyness information (step S32). Specifically, the determination unit 22 acquires the busyness information by calculating the busyness information using the user state information. Next, the determination unit 22 determines whether the user is busy (step S33). Specifically, the determination unit 22 determines whether the user is busy by using the busyness information. In the present embodiment, the index calculated using the user state information is the degree of busyness of the user, and the service provision condition is a condition that the user is busy (a condition that the degree of busyness of the user exceeds a threshold).

When the user is not busy (No in step S33), the processing from step S31 is repeated. When the user is busy (Yes in step S33), the information processing unit 2 of the robot 1 generates a command for providing the housekeeping service (step S34). Specifically, when the determination unit 22 determines that the user is busy, the determination unit generates instruction information giving an instruction to start provision of the housekeeping service, and outputs the generated instruction information to the operation control unit 23. The operation control unit 23 generates a command for providing the housekeeping service on the basis of the instruction information, and outputs the generated command to the movable unit 3.

In addition, in a case where the busyness information indicates a degree of business at three or more levels, the determination unit 22 may determine Yes in step S33 in a case where the degree of busyness exceeds the threshold, and may determine No in step S33 in a case where the degree of business is equal to or less than the threshold. Note that, here, it is assumed that the larger the value of the degree of busyness, the busier the user. Furthermore, the determination unit 22 may determine the content of the housekeeping service according to the degree of busyness. For example, in a case where the busyness is indicated by a three-level numerical value from one to three, the determination unit 22 may determine the content of the housekeeping service according to the degree of busyness, such as determining to provide a housekeeping service that performs housework for laundry in a case where the degree of business is two, and providing a housekeeping service that performs housework for laundry and cleaning in a case where the degree of busyness is three.

After step S34, the robot 1 provides the housekeeping service (step S35), and the processing from step S31 is repeated. Specifically, in step S35, the movable unit 3 starts operation in response to a command received from the operation control unit 23, so that the housekeeping service is provided.

In addition, in the above-described example, the housekeeping service is performed when the user is busy. However, in a case where the housekeeping service includes a service that performs tidying up and/or cleaning of a predetermined target area, the determination unit 22 may determine the timing to execute the service by using information indicating the state of the target area. The target area is an area targeted for service provision, and is an example of an area managed by the user. Information indicating the state of the target area is also an example of the user information.

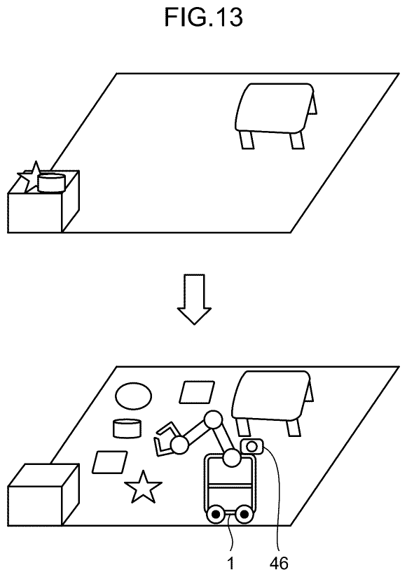

FIG. 13 is a diagram illustrating an example of a tidying service of a target area according to the present embodiment. In FIG. 13, a reference picture indicating a reference state of the target area is illustrated in an upper portion, and a picture in which the target area is captured is illustrated in a lower portion. For example, captured data indicating a video image in which a target area is captured is acquired as user information by the camera 46 mounted on the robot 1 or another camera (not illustrated) capable of capturing the target area.

The determination unit 22 of the information processing unit 2 of the robot 1 stores in advance the video of the reference state in the target area as the reference picture. The determination unit 22 of the robot 1 may acquire the reference picture via the acquisition unit 21 when the user instructs the robot 1 to acquire the reference picture in a state where the target area is tidied up. That is, the reference picture may be learned by providing correct data indicating a tidied-up state by the user and acquiring corresponding captured data. Alternatively, for example, the determination unit 22 acquires captured data obtained by capturing the target area in a certain period which is a certain period such as one week or one month. Then, the determination unit 22 may classify the captured data into groups having similar videos, and use, as the reference picture, the captured data of the group estimated to have the largest floor portion in the target area among the classified groups. The method of determining the reference picture is not limited to the above-described example. Furthermore, the determination of the reference picture is not limited to the example performed by the determination unit 22, and may be performed by a learning device different from the robot 1, and the determination unit 22 of the robot 1 may hold the reference picture determined by the learning device.

The determination unit 22 determines whether the target area has changed from the predetermined reference state based on the captured data. When determining that the target area has changed from the reference state, the determination unit 22 determines to provide the service of cleaning and/or tidying up, and instructs the operation control unit 23 to generate a command for providing the service determined. For example, when determining that the state of the object in the target area has changed from the reference state using the captured data indicating the current state of the target area, the determination unit 22 determines to execute the tidying service. For example, in a case where it is determined that an object is present for a certain period of time or more in a portion where there is no object in the reference picture and the floor is provided, the determination unit 22 determines that the state of the object in the target area has changed from the reference state. In the example illustrated in FIG. 13, in the video (the video indicated by the captured data) illustrated in the lower portion, objects are scattered from the reference state (the state corresponding to the reference picture). When this state continues for a certain period of time or more, the robot 1 executes the tidying service. Note that the determination unit 22 may determine to execute the tidying service when it is determined that the user is busy and the state of the object in the target area has changed from the reference state, or may determine to execute the tidying service when it is determined that the state of the object in the target area has changed from the reference state regardless of whether the user is busy.

In addition, as the reference state, the reference position may be set in advance for each object to be tidied up. The determination unit 22 may determine to execute the tidying service when it is determined that the object is away from the reference position by a certain distance or more for a certain period of time or more on the basis of the captured data.

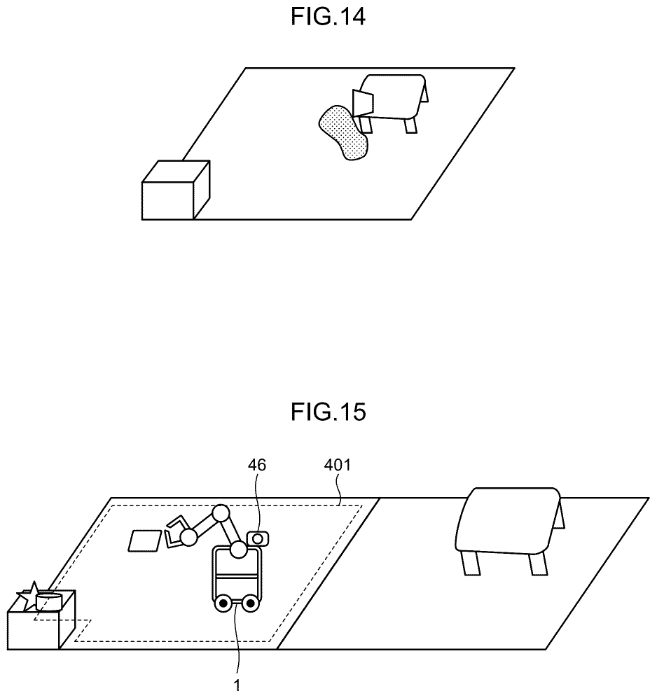

In addition, the determination unit 22 may determine whether the target area is contaminated by using the image indicating the contaminated state and the captured data of the target area, and determine to provide a service for cleaning the area determined to be contaminated when it is determined that the target area is contaminated. For example, the determination unit 22 learns the image in the contaminated state, and thus, when it is determined that the target area is contaminated based on the captured data, the determination unit 22 determines to execute the cleaning service for removing the contamination, and instructs the operation control unit 23 to execute the cleaning service. FIG. 14 is a diagram illustrating a state in which liquid has spilled on the floor in the target area of the present embodiment. By learning the image in which the liquid is spilled as the image in the dirty state in advance, the determination unit 22 may determine to execute the cleaning service for cleaning the dirt when the liquid is spilled on the floor, and instruct the operation control unit 23 to execute the cleaning service for cleaning the dirt. In addition, by separately learning a state in which liquid contamination occurs and a state in which contamination due to a solid material such as soil and powder occurs, the determination unit 22 may determine the content of cleaning such as wiping and cleaning for sucking dust according to the state of the target area. Note that the method of determining whether there is dirt may be, for example, a method of determining whether there is dirt in the target area using a detection result of a sensor that measures dirt itself, such as a dust sensor, or a method of determining whether there is dirt in the target area using a video (image of dirt or dirt) representing the dirt itself and captured data of the target area. That is, for example, the determination unit 22 may determine whether the target area is contaminated by using the detection result of the state of the target area, and the method of determining whether the target area is contaminated is not limited to the above example.

In addition, the determination unit 22 may determine whether the specific area has changed from a predetermined reference state based on captured data obtained by capturing the specific area set by the user among the target areas, and may determine to provide the service of cleaning and/or tidying up the specific area when it is determined that the specific area has changed from the reference state. For example, the user may set a specific area that the user wants to always clean. FIG. 15 is a diagram illustrating an example of a specific area according to the present embodiment. For example, it is assumed that the target area where the robot 1 cleans is two rooms illustrated in FIG. 15. Then, for example, in a case where an infant is often in the room on the left side in FIG. 15, the user designates a specific area 401 and designates the specific area 401 such that there is no object at all times in order to avoid the infant from picking up and mouthing a dropped object. Accordingly, when determining that there is an object in the specific area 401 based on the captured data obtained by capturing the specific area 401, the determination unit 22 may determine to execute the tidying service for tidying up the object and instruct the operation control unit 23 to execute the tidying service for tidying up the object.

Further, the robot 1 may perform the operation of the second embodiment and/or the operation of the third embodiment, and the operation described in the fourth embodiment. For example, the robot 1 may provide the service described in the second embodiment in a case where the service provision condition is satisfied based on the amount of utterance, may provide the service described in the present embodiment in a case where the service provision condition is satisfied based on the work state information, and may provide the service described in the present embodiment in a case where the service provision condition that the user is busy is satisfied. Furthermore, for example, the robot 1 may provide the service described in the second embodiment in a case where the service provision condition is satisfied based on the amount of utterance, and may provide the service in a case where the service provision condition based on the state of the target area of the specific area is satisfied (for example, in a case where there is a change from the reference state, in a case where it is determined that there is dirt, or the like). In addition, the robot 1 may provide a service in a case where a service provision condition based on the work state information is satisfied, and may provide a service in a case where a service provision condition based on the state of the target area or the specific area is satisfied (for example, in a case where there is a change from the reference state, in a case where it is determined that there is dirt, or the like).

As described above, in the present embodiment, the condition that the user is busy is used as the service provision condition, and the robot 1 provides the housekeeping service when the user is busy. As a result, the user can receive the provision of the housekeeping service without giving an instruction to the robot when the user is busy. This improves the comfort of the user's life.

In addition, in a case where the state of the target area has changed from the reference state, the robot 1 may provide the housekeeping service. In this case as well, the user can receive the provision of the housekeeping service without instructing the robot 1. This improves the comfort of the user's life.

### Fifth Embodiment

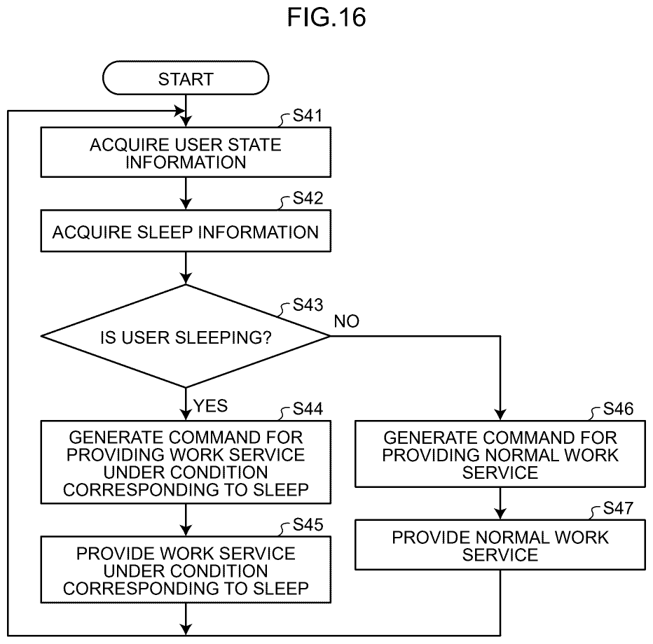

FIG. 16 is a flowchart illustrating an example of the operation of the robot 1 according to the fifth embodiment. In the present embodiment, a specific example of a service provided by the robot 1 described in the first embodiment and a service provision condition will be described. A configuration of the service providing system 100 of the present embodiment and a configuration of each device constituting the service providing system 100 are similar to those of the first embodiment. Here, the service providing system 100 having the configuration illustrated in FIG. 1 of the first embodiment will be described as an example, but the operation of the present embodiment can be similarly applied to the exemplary configuration illustrated in FIG. 4 or 5 of the first embodiment. As described in the first embodiment, the function of each device is not limited to the example illustrated in FIGS. 4 and 5. Components having the same functions as those in the first embodiment are explained by being denoted by the same reference signs as those in the first embodiment. Hereinafter, differences from the first embodiment will be mainly described.

In the present embodiment, the information processing unit 2 of the robot 1 determines whether the user is sleeping on the basis of the user's vital data and/or the captured data obtained by capturing the user, and in a case where the user is sleeping, the robot 1 provides the work service under a condition suitable for a case where the user is sleeping. A condition suitable for a case where the user is sleeping may be to set a silent mode with less noise than a normal mode, or to provide a service in a second area far from the first area where the user is present. The work service is, for example, a housekeeping service, but is not limited thereto as long as it is a service using the movable unit 3 of the robot 1. The user's vital data and/or the captured data obtained by capturing the user is an example of the user information.

The processing illustrated in FIG. 16 is performed before the start of the work service, for example, in a case where the robot 1 determines that the service provision condition for starting the work service is satisfied on the basis of the user information. For example, when the target area changes as described in the fourth embodiment, the processing illustrated in FIG. 16 is started. Alternatively, the processing illustrated in FIG. 16 may be performed when the robot 1 performs a predetermined work at regular time every day or performs a work reserved by the user.

As illustrated in FIG. 16, the information processing unit 2 of the robot 1 acquires user state information (step S41). In step S41, specifically, the acquisition unit 21 acquires the user state information as the user information from the detection device 4, and outputs the acquired user state information to the determination unit 22. The user state information in the present embodiment includes, for example, the user's vital data and/or the captured data obtained by capturing the user. For example, as described in the first embodiment, the vital data is acquired by the wearable terminal 44 incorporating a sensor capable of detecting a vital, the detection device 4 which is a non-contact sensor capable of detecting a vital, or the like.

The information processing unit 2 of the robot 1 acquires sleep information (step S42). Specifically, the determination unit 22 acquires the sleep information indicating the sleep state of the user by estimating the sleep state (sleeping or not sleeping) of the user using the user state information. Next, the determination unit 22 determines whether the user is sleeping (step S43). Specifically, the determination unit 22 determines whether the user is sleeping by using the sleep information. In the present embodiment, the index calculated using the user information is the sleep state of the user, and the service provision condition is a condition that the user is sleeping.

When the user is in the sleep state (Yes in step S43), the information processing unit 2 of the robot 1 generates a command for providing a work service under a condition corresponding to sleep (step S44). Specifically, when the determination unit 22 determines that the user is in the sleep state, the determination unit generates instruction information giving an instruction to start providing the work service under the condition corresponding to sleep, and outputs the generated instruction information to the operation control unit 23. The operation control unit 23 generates a command for providing the work service under the condition corresponding to sleep on the basis of the instruction information, and outputs the generated command to the movable unit 3. The condition corresponding to sleep is a condition for performing work so as not to wake the sleeping user. For example, in a case where the work service is a service that performs cleaning using a vacuum cleaner, the condition corresponding to sleep may be a condition that cleaning is performed in a room (second area) farther from a room (first area) in which the user who is sleeping is present, a condition that cleaning is performed in a silent mode quieter than normal driving, or a combination thereof.

After step S44, the robot 1 provides the work service under the condition corresponding to sleep (step S45), and the processing from step S41 is repeated. Specifically, in step S45, the movable unit 3 starts operation in response to a command received from the operation control unit 23, so that the work service is provided under the condition corresponding to sleep.

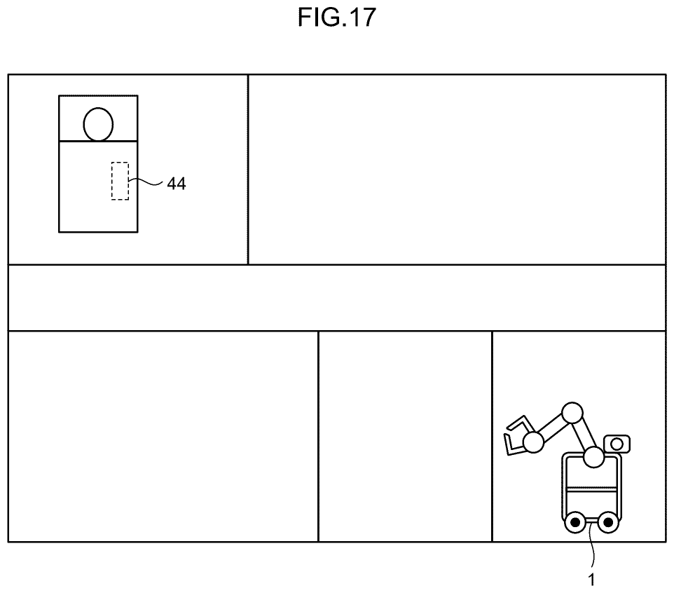

FIG. 17 is a diagram illustrating an example of service provision by the robot 1 of the present embodiment. As illustrated in FIG. 17, it is assumed that the user wearing the wearable terminal 44 capable of acquiring vital data is sleeping in the upper left room on the paper. In this case, the robot 1 cleans the lower right room on the paper farthest from the upper left room. In addition, the robot 1 may clean not only the lower right room farthest from the upper left room but also the second farthest room. For example, it may be determined in advance to permit cleaning of a predetermined number of rooms in descending order, or a condition may be determined by a distance such as cleaning a room at a distance equal to or more than a certain value from a room in which the user who is sleeping is present. For example, as illustrated in FIG. 17, the determination unit 22 of the robot 1 holds information indicating a room layout of a target area to be cleaned, and determines a room to be cleaned on the basis of the position of the user and the room layout.

Returning to FIG. 16, when the user is not in the sleep state (No in step S43), the information processing unit 2 of the robot 1 generates a command for providing a normal work service (step S46). Specifically, when the determination unit 22 determines that the user is not in the sleep state, the determination unit generates instruction information giving an instruction to provide a normal work service, and outputs the generated instruction information to the operation control unit 23. The operation control unit 23 generates a command for providing a normal work service on the basis of the instruction information, and outputs the generated command to the movable unit 3. For example, in a case where the work service is a service for performing cleaning using a vacuum cleaner, the normal work service may be a condition for performing cleaning including a room in which the user is sleeping, a condition for performing cleaning in a normal driving mode, or a combination thereof.

After step S46, the robot 1 provides a normal work service (step S47), and the processing from step S41 is repeated. Specifically, in step S47, the movable unit 3 starts operation in response to a command received from the operation control unit 23, so that a normal work service is provided.

In the present embodiment, it is determined whether the user is sleeping when the robot 1 executes the work while satisfying the service provision condition, and when it is determined that the user is sleeping, the work service is provided under the condition corresponding to the sleeping. As a result, the user can receive the provision of the work service under the corresponding condition during sleep without giving an instruction to the robot during sleep. As a result, the user can receive the work service without disturbing the sleep of the user.

In addition, also in a case where the processing illustrated in FIG. 16 is performed when the robot 1 performs a predetermined work at regular time every day or performs a work reserved by the user, the robot 1 determines the timing of executing the work service performed under the condition corresponding to sleep on the basis of the index calculated on the basis of the user information. In this case, a condition that the user is sleeping is used as the service provision condition, and when it is determined that the user is sleeping, the work service is provided under a condition corresponding to sleeping. Also in this case, the robot 1 may perform at least one of the operation of the second embodiment, the operation of the third embodiment, and the operation of the fourth embodiment, and the operation described in the fifth embodiment.

The configurations described in the above-mentioned embodiments indicate examples. The embodiments can be combined with another well-known technique and with each other, and some of the configurations can be omitted or changed in a range not departing from the gist.

### Reference Signs List

1, 1a, 1b robot; 2 information processing unit; 3 movable unit; 4 detection device; 5 information providing device; 6, 6a Information processing device; 21 acquisition unit; 22 determination unit; 23, 23a operation control unit; 24 transmission unit; 25 command generation unit; 31 movement mechanism; 32 work mechanism; 33 reception unit; 41 microphone-equipped Web camera; 42 thermometer; 44 wearable terminal; 45 portable terminal; 46 camera; 100, 100a, 100b service providing system.

1. An information processing device that controls a robot that includes a mover and provides a service to a user by operating the mover, the information processing device comprising:
an acquisition circuitry to acquire user information including a state of the user and/or an environment around the user;
a determination circuitry to determine a timing to provide the service by using the user information; and
a command generation circuitry to generate a command for the robot to provide the service at the timing based on the timing determined.

2. The information processing device according to claim 1, wherein
the mover includes:
a movement mechanism that is a driver to move a position of the robot; and
a work mechanism that is a driver that executes work for providing the service.

3. The information processing device according to claim 1, wherein
the user information includes utterance information that is a detection result of utterance of the user, and
the determination circuitry calculates an amount of utterance using the utterance information, and determines a timing to provide the service based on the amount of utterance calculated.

4. The information processing device according to claim 3, wherein
the service includes a drink carry service for carrying a drink to the user.

5. The information processing device according to claim 1, wherein
the user information includes end information indicating whether a user work that is work of the user has ended, and
the determination circuitry determines whether the user work has ended based on the end information, and when determining that the user work has ended, the determination circuitry determines to provide a first service that is the service determined in advance when the user work has ended, and instructs the command generation circuitry to generate the command for providing the first service.

6. The information processing device according to claim 5, wherein the first service includes a service for tidying up a desk of the user.

7. The information processing device according to claim 1, wherein
the user information includes interruption information indicating whether a user work that is work of the user has been interrupted, and
the determination circuitry determines whether the user work has been interrupted based on the interruption information, and when determining that the user work has been interrupted, the determination circuitry determines to provide a second service that is the service determined in advance when the user work has been interrupted, and instructs the command generation circuitry to generate the command for providing the second service.

8. The information processing device according to claim 7, wherein the second service includes a drink carry service for conveying a drink to the user.

9. The information processing device according to claim 1, wherein
the user information includes information indicating busyness of the user, and
the determination circuitry determines a degree of busyness of the user based on the information indicating busyness, and determines a timing to provide the service based on the degree of busyness.

10. The information processing device according to claim 9, wherein when the degree of busyness exceeds a threshold, the determination circuitry determines to provide a housekeeping service as the service, and instructs the command generation circuitry to generate the command for providing the housekeeping service.

11. The information processing device according to claim 10, wherein the information indicating busyness of the user includes information indicating a moving speed of the user and/or information indicating a schedule of the user.

12.-13. (canceled)

14. The information processing device according to claim 1, wherein the determination circuitry determines whether the user is sleeping based on the user information, determines to provide the service in a second area far from a first area in which the user exists in a case where the user is sleeping, and instructs the command generation circuitry to generate the command for providing the service in the second area.

15. (canceled)

16. The information processing device according to claim 1, wherein
the user information includes captured data obtained by capturing a target area in which the service is provided, and
the determination circuitry determines whether the target area has changed from a predetermined reference state based on the captured data, and when determining that the target area has changed from the reference state, the determination circuitry determines to provide a service of cleaning and/or tidying as the service, and instructs the command generation circuitry to generate the command for providing the service determined.

17. The information processing device according to claim 1, wherein
the user information includes captured data obtained by capturing a specific area set by the user among a target area in which the service is provided, and
the determination circuitry determines whether the specific area has changed from a predetermined reference state based on the captured data, and when determining that the specific area has changed from the reference state, the determination circuitry determines to provide a service of cleaning and/or tidying the specific area as the service, and instructs the command generation circuitry to generate the command for providing the service determined.

18. The information processing device according to claim 16, wherein the determination circuitry determines whether the target area is contaminated by using a detection result of the state of the target area, and when determining that the target area is contaminated, the determination circuitry determines to provide a service for cleaning a place determined to be contaminated as the service, and instructs the command generation circuitry to generate the command for providing the service determined.

19. The information processing device according to claim 1, wherein
the user information includes information indicating a language used by the user, and
the determination circuitry determines a language used by the robot in the service based on information indicating a language used by the user.

20. The information processing device according to claim 1, wherein
the user information includes information indicating a region in which the user receives the service, and
the determination circuitry sets a permitted time zone that is a time zone in which provision of the service is permitted based on information indicating a region where the user exists, and instructs the command generation circuitry to generate the command for providing the service in a case where the timing determined is within the permitted time zone.

21. (canceled)

22. A robot that includes a mover and provides a service to a user by operating the mover, the robot comprising:
an acquisition circuitry to acquire user information including a state of the user and/or an environment around the user;
a determination circuitry to determine a timing to provide the service by using the user information; and
an operation control circuitry to generate a command for the robot to provide the service at the timing based on the timing determined, and output the command generated to the mover.

23. (canceled)

24. An information processing method for an information processing device that controls a robot that includes a mover and provides a service to a user by operating the mover, the information processing method comprising:
acquiring user information including a state of the user and/or an environment around the user;
of determining a timing to provide the service by using the user information; and
generating a command for the robot to provide the service at the timing based on the timing determined.

25. (canceled)

26. The information processing device according to claim 17, wherein the determination circuitry determines whether the target area is contaminated by using a detection result of the state of the target area, and when determining that the target area is contaminated, the determination circuitry determines to provide a service for cleaning a place determined to be contaminated as the service, and instructs the command generation circuitry to generate the command for providing the service determined.
